(19) United States
(12) Patent Application Publication
(10) Pub. No.: US 2012/0268431 A1
(43) Pub. Date: Oct. 25, 2012

(54) DRIVE CIRCUIT FOR DISPLAY, DISPLAY, AND METHOD OF DRIVING DISPLAY

(75) Inventor: Kenichi Kitamura, Kanagawa (JP)

(73) Assignee: SONY CORPORATION, Tokyo (JP)

(21) Appl. No.: 13/443,009

(22) Filed: Apr. 10, 2012

(30) Foreign Application Priority Data
Apr. 20, 2011 (JP) 2011-094165

(51) Int. Cl. G06F 3/038

(52) U.S. Cl. 345/204

(57) ABSTRACT

In a drive circuit for display, the drive circuit includes: a pixel signal generation section generating a pixel signal and supplying the pixel signal to a display section, the pixel signal being inverted every frame period in each of a first period and a second period, the first period and the second period being alternately provided; and a writing control section controlling writing of the pixel signal into the display section to be performed in each of the first period and the second period except for a leading period, the leading period being provided in each of the first period and the second period, and having a predetermined length from start of each of the first period and the second period.

### BACKGROUND

The present technology relates to a drive circuit driving a display which performs display based on an interlaced image signal, a display including the drive circuit, and a method of driving such a display.

In recent years, in displays, liquid crystal displays have been supplanting CRT (Cathode Ray Tube) displays. Since liquid crystal displays are allowed to have a smaller thickness than CRT displays, liquid crystal displays are allowed to easily achieve space-saving, and since liquid crystal displays use less power, liquid crystal displays are advantageous in terms of ecology.

In the field of displays, an interlaced image signal is frequently used. In the interlaced image signal, image information of each frame image is divided into image information of two field images each containing alternate line images of the frame image. When the interlaced image signal is supplied to a CRT display, for example, the CRT display alternately displays these two field images at their respective positions. On the other hand, when the interlaced image signal is supplied to a liquid crystal display, for example, the liquid crystal display converts the interlaced image signal into a progressive image signal by so-called IP conversion to produce an original frame image, and performs display based on the produced frame image. Moreover, there is a liquid crystal display which includes a display section having the same number of pixels as that of each field image of the interlaced image signal, and displaying, in a time-divisional manner, respective field images as it is without performing IP conversion. The display not performing IP conversion is allowed to perform display based on the interlaced image signal with a simpler configuration than that of a display performing IP conversion.

In a typical display, there occurs a phenomenon called “burn-in” in which, for example, when one image is displayed for a long period of time, the image displayed for a long period of time slightly appears even after another image is displayed. In the liquid crystal display, such a phenomenon also occurs, and various attempts against the phenomenon have been proposed. For example, Japanese Unexamined Patent Application Publication No. H8-191421 discloses a liquid crystal display not performing IP conversion, which is driven by inverting a pixel signal every frame, and changes a method of inverting the pixel signal at predetermined intervals.

### SUMMARY

Higher image quality is desired in a typical display, and a further improvement in image quality in a liquid crystal display not performing IP conversion is desired.

It is desirable to provide a drive circuit for display, a display, and a method of driving a display which are capable of improving image quality.

According to an embodiment of the technology, there is provided a drive circuit for display, the drive circuit including: a pixel signal generation section generating a pixel signal and supplying the pixel signal to a display section, the pixel signal being inverted every frame period in each of a first period and a second period, the first period and the second period being alternately provided; and a writing control section controlling writing of the pixel signal into the display section to be performed in each of the first period and the second period except for a leading period, the leading period being provided in each of the first period and the second period, and having a predetermined length from start of each of the first period and the second period.

According to an embodiment of the technology, there is provided a display including: a pixel signal generation section generating a pixel signal, the pixel signal being inverted every frame period in each of a first period and a second period, the first period and the second period being alternately provided; a display section performing display based on the pixel signal; and a writing control section controlling writing of the pixel signal into the display section to be performed in each of the first period and the second period except for a leading period, the leading period being provided in each of the first period and the second period, and having a predetermined length from start of each of the first period and the second period.

According to an embodiment of the technology, there is provided a method of driving a display including: generating a pixel signal and supplying the pixel signal to a display section, the pixel signal being inverted every frame period in each of a first period and a second period, the first period and the second period being alternately provided; and controlling writing of the pixel signal into the display section to be performed in each of the first period and the second period except for a leading period, the leading period being provided in each of the first period and the second period, and having a predetermined length from start of each of the first period and the second period.

In the drive circuit for display, the display, and the method of driving a display according to the embodiment of the technology, in each of the first period and the second period alternately provided, the pixel signal inverted every frame period is supplied to the display section. At this time, the pixel signal is written into the display section in each of the first period and the second period except for the leading period with a predetermined length from start of each of the first period and the second period.

In the drive circuit for display, the display, and the method of driving a display according to the embodiment of the technology, the pixel signal is written into the display section in each of the first period and the second period except for the leading period; therefore, image quality is allowed to be improved.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a display according to a first embodiment of the technology.

FIGS. 2A to 2C are explanatory diagrams for describing an interlaced image.

FIG. 3 is a circuit diagram illustrating a configuration example of an inversion control section illustrated in FIG. 1.

FIGS. 4A and 4B are explanatory diagrams for describing display based on a first field image and a second field image.

FIG. 5 is an explanatory diagram illustrating a configuration example of a display section illustrated in FIG. 1.

FIG. 6 is a timing waveform chart illustrating an operation example of the display illustrated in FIG. 1.

FIG. 7 is another timing waveform chart illustrating an operation example of the display illustrated in FIG. 1.

FIG. 8 is a timing waveform chart illustrating an operation example of an inversion signal generation section and an inversion signal control section illustrated in FIG. 1.

FIGS. 9A to 9C are explanatory diagrams for describing an example of the interlaced image.

FIGS. 10A and 10B are explanatory diagrams for describing display of the image illustrated in FIGS.9A to 9C.

FIG. 11 is another timing waveform chart illustrating an operation example of the display illustrated in FIG. 1.

FIG. 12 is a block diagram illustrating a configuration example of a display according to a comparative example.

FIG. 13 is a timing waveform chart illustrating an operation example of the display according to the comparative example.

FIG. 14 is a block diagram illustrating a configuration example of a display according to a modification of the first embodiment.

FIG. 15 is a circuit diagram illustrating a configuration example of an inversion control section illustrated in FIG. 14.

FIG. 16 is a circuit diagram illustrating a configuration example of an inversion control section according to another modification of the first embodiment.

FIG. 17 is a block diagram illustrating a configuration example of a display according to a second embodiment.

FIG. 18 is a flow chart illustrating an operation example of the display illustrated in FIG. 17.

FIG. 19 is a block diagram illustrating a configuration example of a display according to a third embodiment.

FIG. 20 is a flow chart illustrating an operation example of the display illustrated in FIG. 19.

FIG. 21 is a flow chart illustrating an operation example of a display according to a modification of the third embodiment.

### DETAILED DESCRIPTION OF THE PREFERRED EMBODIMENTS

Preferred embodiments of the technology will be described in detail below referring to the accompanying drawings. It is to be noted that description will be given in the following order.
1. First Embodiment
2. Second Embodiment
3. Third Embodiment

### 1. First Embodiment

### [Configuration Example]

### (Whole Configuration Example)

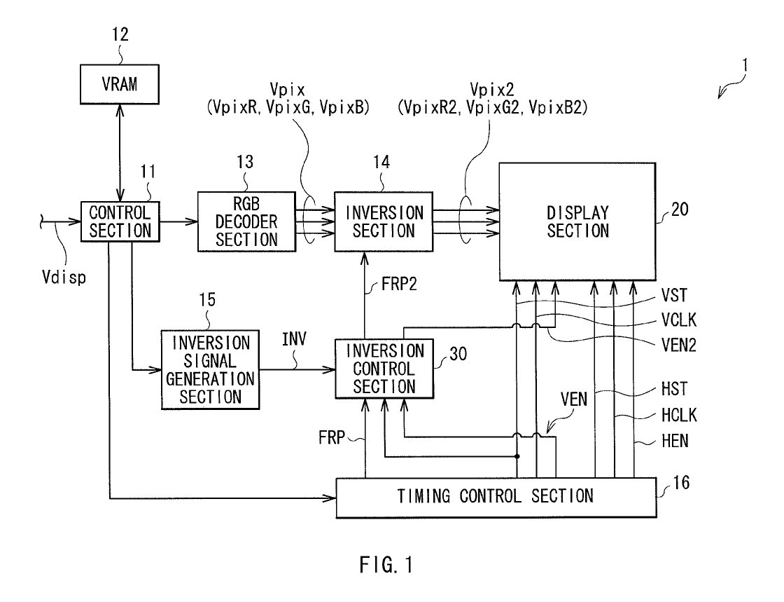

FIG. 1 illustrates a configuration example of a display according to a first embodiment. A display 1 performs display based on a supplied interlaced image signal without performing IP conversion. It is to be noted that a drive circuit for display and a method of driving a display according to an embodiment of the technology are embodied by the embodiment, and will be also described.

The display 1 includes a control section 11, a timing control section 16, an inversion signal generation section 15, an inversion control section 30, a VRAM (Video RAM) 12, an RGB decoder section 13, an inversion section 14, and a display section 20.

The control section 11 is a circuit supplying, based on a supplied image signal Vdisp, control signals to the VRAM 12, the RGB decoder section 13, the inversion signal generation section 15, and the timing control section 16 to control them to operate in synchronization with one another.

The image signal Vdisp is an interlaced image signal, and image information of a plurality of (two in this case) field images is alternately supplied to the display 1.

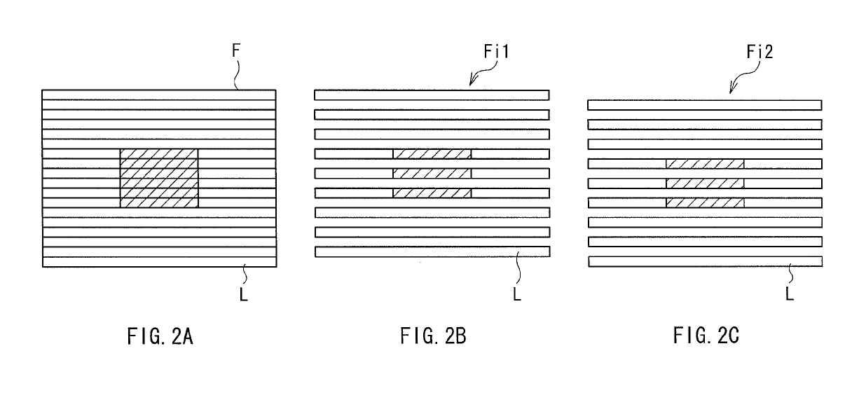

FIGS. 2A to 2C schematically illustrate an example of the interlaced image signal, and FIGS. 2A, 2B, and 2C illustrate a frame image F, a first field image Fi1, and a second field image Fi2, respectively.

As illustrated in FIG. 2A, the frame image F is configured of a plurality of line images L. For example, in the case where the image signal Vdisp is an SD (Standard Definition) signal, the frame image F includes pixel information of 720 (horizontal) by 480 (vertical) pixels. Moreover, for example, in the case where the image signal Vdisp is an HD (High Definition) signal, the frame image F includes pixel information of 1920 (horizontal) by 1080 (vertical) pixels.

The first field image Fi1 and the second field image Fi2 (refer to FIGS. 2B and 2C) each contain alternate line images L of the frame image F (refer to FIG. 2A). For example, field images (the first field image Fi1 and the second field image Fi2) each include pixel information of 720 (horizontal) by 240 (vertical) pixels in the case where the image signal Vdisp is the SD signal, and pixel information of 1920 (horizontal) by 540 (vertical) pixels in the case where the image signal Vdisp is the HD signal.

The control section 11 writes, into the VRAM 12, image information of each field image supplied by the image signal Vdisp, and reads image data from the VRAM 12 when display is performed. Moreover, the control section 11 supplies image information read from the VRAM 12 and a control signal to the RGB decoder section 13, and supplies a control signal to the inversion signal generation section 15 and the timing control section 16.

The timing control section 16 generates a plurality of control signals in response to the control signal from the control section 11 to supply the control signals to the display section 20 and the inversion control section 30. More specifically, the timing control section 16 generates a horizontal synchronization signal HST, a clock signal HCLK, a horizontal enable signal HEN, a vertical synchronization signal VST, and a clock signal VCLK to supply these signals to the display section 20. Moreover, the timing control section 16 generates an inversion control signal FRP and a vertical enable signal VEN to supply, to the inversion control section 30, these signals together with the vertical synchronization signal VST.

As will be described later, the horizontal synchronization signal HST is a signal having a pulse waveform every horizontal period (1H), and the vertical synchronization signal VST is a signal having a pulse waveform every vertical period (1V). Moreover, as will be described later, the horizontal enable signal HEN and the vertical enable signal VEN control writing of a pixel signal Vpix2 into a sub-pixel SPix. The inversion control signal FRP is a signal inverted every vertical period.

The inversion signal generation section 15 generates a long-period inversion signal INV inverting a logic at intervals of a predetermined plural number of vertical periods in response to a control signal supplied from the control section 11. The logic of the long-period inversion signal INV is inverted, for example, at intervals of approximately 1 minute.

The inversion control section 30 generates an inversion control signal FRP2 and a vertical enable signal VEN2 based on the long-period inversion signal INV supplied from the inversion signal generation section 15, the inversion control signal FRP, vertical synchronization signal VST, and the vertical enable signal VEN supplied from the timing control section 16.

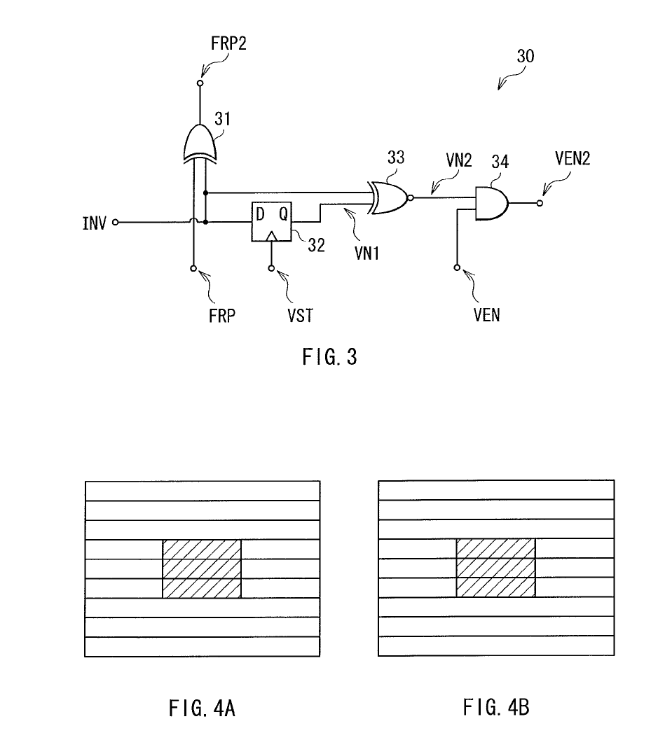

FIG. 3 illustrates a configuration example of the inversion control section 30. The inversion control section 30 includes an EX-OR circuit 31, a D-type flip-flop circuit 32, an EX-NOR circuit 33, and an AND circuit 34. The EX-OR circuit 31 determines an exclusive OR of the long-period inversion signal INV and the inversion control signal FRP to output a resultant signal as the inversion control signal FRP2. The D-type flip-flop circuit 32 receives the long-period inversion signal INV at a data input terminal thereof and the vertical synchronization signal VST at a clock input terminal thereof, and samples the long-period inversion signal INV in synchronization with the vertical synchronization signal VST to output a sampled result as a signal VN1. The EX-NOR circuit 33 determines an inverted exclusive OR of the long-period inversion signal INV and an output signal (the signal VN1) from the D-type flip-flop circuit 32 to output a resuntant signal as a signal VN2. The AND circuit 34 determines an AND of an output signal (the signal VN2) from the EX-NOR circuit 33 and the vertical enable signal VEN to output a resultant signal as the vertical enable signal VEN2.

In this configuration, the inversion control section 30 outputs, as the inversion control signal FRP2, a signal with the same level as that of the inversion control signal FRP in the case where the long-period inversion signal INV is at the low level, and an inverted signal of the inversion control signal FRP in the case where the long-period inversion signal INV is at the high level. Moreover, the inversion control section 30 generates the vertical enable signal VEN2 which is switched to the low level in a first vertical period after the long-period inversion signal INV is inverted, and is switched to a signal with the same level as that of the vertical enable signal VEN in other vertical periods.

The VRAM 12 is a storage section holding image information, and holds image information of the field images (the first field image Fi1 and the second field image Fit) supplied from the control section 11, and outputs the image information based on a request from the control section 11.

The RGB decoder section 13 generates pixel signals VpixR, VpixG, and VpixB which are analog signals of red (R), green (G), and blue (B) components based on the image information and the control signal supplied from the control section 11. It is to be noted that, in the following description, for convenience sake, “pixel signal Vpix” is used as appropriate to represent any one of the pixel signals VpixR, VpixG, and VipxB.

It is to be noted that, for example, the control section 11, the inversion signal generation section 15, and the RGB decoder section 13 may be configured of, for example, a microcontroller unit (MCU).

The inversion section 14 controls an inversion operation on the pixel signals VpixR, VpixG, and VpixB supplied from the RGB decoder section 13 in response to the inversion control signal FRP2 supplied from the inversion control section 30 to output resultant signals as pixel signals VpixR2, VpixG2, and VpixB2. More specifically, as will be described later, the inversion section 14 outputs the pixel signals VpixR, VpixG, and VpixB as it is as the pixel signals VpixR2, VpixG2, and VpixB2 in the case where the inversion control signal FRP2 is at the high level, and outputs inverted signals of the pixel signals VpixR, VpixG, and VpixB as the pixel signals VpixR2, VpixG2, and VpixB2 in the case where the inversion control signal FRP2 is at the low level. It is to be noted that, in the following description, for convenience sake, “pixel signal Vpix2” is used as appropriate to represent any one of the pixel signals VpixR2, VpixG2, and VpixB2.

The display section 20 is a liquid crystal display section, and performs display based on the pixel signals VpixR2, VpixG2, and VpixB2 supplied from the inversion section and various control signals supplied from the inversion control section 30 and the timing control section 16. In this example, the display section 20 is of a normally white type. However, the display section 20 is not limited thereto, and may be of a normally black type. The display section 20 includes the same number of pixels as that of pixels in each field image. In other words, in the display section 20, the number of pixels in a vertical direction is half of that in the frame image F.

FIGS. 4A and 4B illustrate display of an image in the display section 20, and FIG. 4A illustrates the case where the first field image Fi1 is displayed, and FIG. 4B illustrates the case where the second field image Fi2 is displayed. FIGS. 4A and 4B correspond to FIGS. 2B and 2C, respectively. More specifically, when the first field image Fi1 is displayed, an image in FIG. 2B is displayed as illustrated in FIG. 4A, and when the second field image Fi2 is displayed, an image in FIG. 2C is displayed as illustrated in FIG. 4B. In the display 1, field images included in the interlaced image signal are alternately displayed without performing IP conversion.

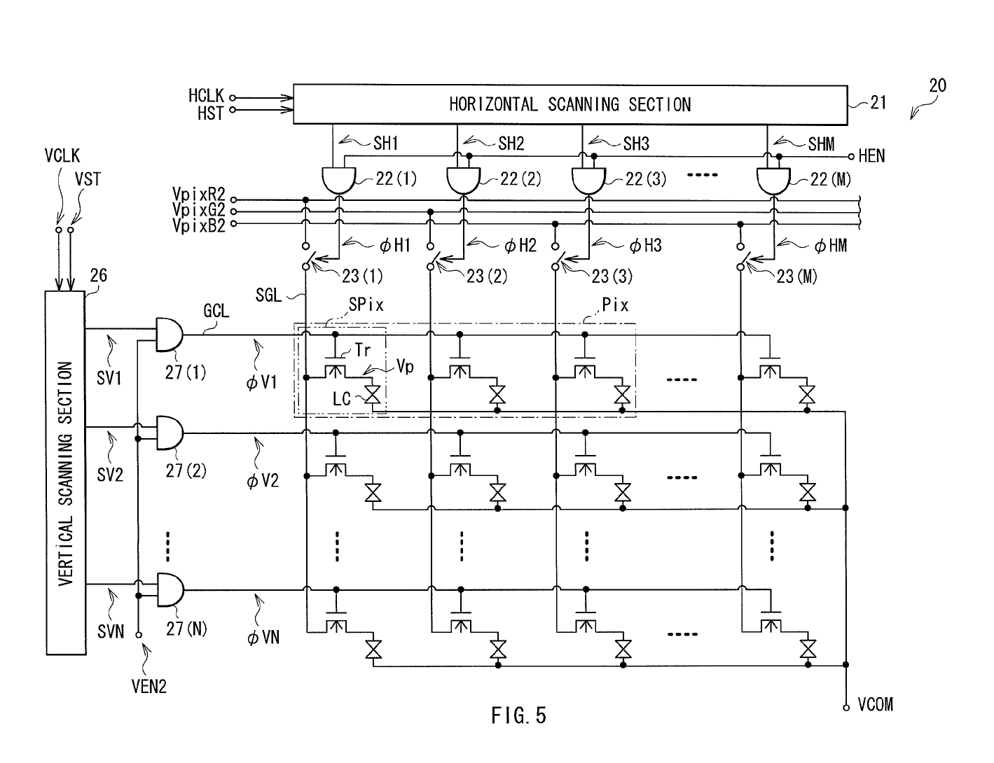

FIG. 5 illustrates a configuration example of the display section 20. The display section 20 includes a horizontal scanning section 21, a number M of AND circuits 22 (AND circuits 22(1) to 22(M)) and a number M of switches 23 (switches 23(1) to 23(M), a vertical scanning section 26, a number N of AND circuits 27 (AND circuits 27(1) to 27(N)), and pixels Pix arranged in a matrix form.

The horizontal scanning section 21 scans the pixels Pix arranged in a matrix form in a horizontal direction based on the horizontal synchronization signal HST and the clock signal HCLK. The horizontal scanning section 21 is configured of, for example, a shift register, and the horizontal synchronization signal HST and the clock signal HCLK are supplied to a data input terminal and a clock input terminal of the horizontal scanning section 21, respectively. In this configuration, the horizontal scanning section 21 sequentially outputs, from respective stages of the shift register, pulse signals as scanning signals SH1 to SHM in synchronization with the clock signal HCLK.

The AND circuits 22(1) to 22(M) are circuits determining ANDs of the scanning signals SH1 to SHM supplied from the horizontal scanning section 21 and the horizontal enable signal HEN to output resultant signals as scanning signals φH1 to φHM.

The switches 23(1) to 23(M) are switches turned on or off in response to output signals (the scanning signals φH1 to φHM) from the corresponding AND circuits 22(1) to 22(M). The switches 23(1) to 23(M) each are configured of, for example, an analog switch using a thin film transistor (TFT). The pixel signal Vpix2 is supplied from the inversion section 14 to one end of each of the switches 23(1) to 23(M), and the other end of each of the switches 23(1) to 23(M) is connected to the pixels Pix through pixel signal lines SGL. More specifically, the pixel signal VpixR2 of red is supplied to the switch 23(1), the pixel signal VpixG2 of green is supplied to the switch 23(2), and the pixel signal VpixB2 of blue is supplied to the switch 23(3). Then, when the switches are turned on, the pixel signals VpixR2, VpixG2, and VpixB2 are supplied to sub-pixels SPix of R, G, and B (which will be described later), respectively, of the pixels Pix through pixel signal lines SGL.

The vertical scanning section 26 scans the pixels Pix arranged in a matrix form in a vertical direction based on the vertical synchronization signal VST and the clock signal VCLK. The vertical scanning section 26 is configured of, for example, a shift register, and the vertical synchronization signal VST and the clock signal VCLK are supplied to a data input terminal and a clock terminal of the vertical scanning section 26, respectively. In this configuration, the vertical scanning section 26 sequentially outputs, from respective stages of the shift register, pulse signals as scanning signals SV1 to SVN in synchronization with the clock signal VCLK.

The AND circuits 27(1) to 27(N) are circuits determining ANDs of the scanning signals SV1 to SVN supplied from the vertical scanning section 27 and the vertical enable signal VEN2 to output resultant signals as scanning signals φV1 to φVN, respectively. Output terminals of the AND circuits 27(1) to 27(N) are connected to the pixels Pix through scanning signal lines GCL.

The pixels Pix are display elements producing a display image. Each of the pixels Pix is configured of three sub-pixels SPix. The sub-pixels SPix each include a TFT device Tr and a liquid crystal device LC. The TFT device Tr is configured of a thin film transistor (TFT), and in this example, the TFT device Tr is configured of an n-channel MOS (Metal Oxide Semiconductor) TFT. A source and a gate of the TFT device Tr are connected to the pixel signal line SGL and the scanning signal line GCL, respectively, and a drain of the TFT device Tr is connected to an end of the liquid crystal device LC. The one end of the liquid crystal device LC is connected to the drain of the TFT device Tr, and a common voltage VCOM (for example, 0 V) is applied to the other end of the liquid crystal device LC.

The sub-pixels SPix arranged in one row in the display section 20 are connected to one another through the scanning signal line GCL. Moreover, the sub-pixels SPix arranged in one column in the display section 20 are connected to one another through the pixel signal line SGL.

In this configuration, in the display section 20, horizontal lines are sequentially selected one by one by driving the vertical scanning section 26 and the AND circuits 27(1) to 27(N) to perform line-sequential scanning on the scanning signal lines in a time-divisional manner. Then, the horizontal scanning section 21 and the AND circuits 22(1) to 22(M) select the pixel signal lines SGL by sequential scanning, and the inversion section 14 supplies the pixel signals Vpix2 to the sub-pixels SPix through the selected pixel signal lines SGL. In each sub-pixel SPix, when the TFT device Tr is on, the pixel signal Vpix2 is written as a pixel potential Vp into an end of the liquid crystal device LC, and when the TFT device Tr is turned off, the end of the liquid crystal device LC is electrically separated from the pixel signal line SGL to be switched to a high impedance state, thereby maintaining the pixel potential Vp.

Moreover, the horizontal enable signal HEN and the vertical enable signal VEN2 control writing of the pixel signals Vpix2 into the sub-pixels SPix. More specifically, in the case where both the horizontal enable signal HEN and the vertical enable signal VEN2 are at the high level, the pixel signals Vpix2 are written into the sub-pixels SPix by the above-described operation. On the other hand, in the case where the horizontal enable signal HEN is at the high level and the vertical enable signal VEN2 is at the low level, all of the scanning signals φV1 to φVN are switched to the low level; therefore, even though the pixel signals Vpix2 are applied to the pixel signal lines SGL, the pixel signals Vpix2 are not written into the sub-pixels SPix. Moreover, in the case where the horizontal enable signal HEN is at the low level, all of the scanning signals φH1 to φHM are switched to the low level; therefore, all of the switches 23(1) to 23(M) are turned off, thereby not applying the pixel signals Vpix2 to the pixel signal lines SGL.

Herein, the RGB decoder section 13 and the inversion section 14 correspond to specific examples of “pixel signal generation section” in the technology. The inversion control section 30 corresponds to a specific example of “writing control section” in the technology. The long-period inversion signal INV corresponds to a specific example of “logic signal” in the technology, and the inversion signal generation section 15 corresponds to a specific example of “logic signal generation section” in the technology. The TFT devices Tr correspond to a specific example of “pixel switches” in the technology. The switches 23(1) to 23(M) correspond to a specific example of “signal-line switches” in the technology.

### [Operations and Functions]

Next, operations and functions of the display 1 according to the embodiment will be described below.

### (Summary of Whole Operation)

First, referring to FIG. 1, a summary of a whole operation of the display 1 will be described below. The control section 11 supplies control signals to the VRAM 12, the RGB decoder section 13, the inversion signal generation section 15, and the timing control section 16 based on the supplied image signal Vdisp to control them to operate in synchronization with one another. The timing control section generates a plurality of control signals to supply the control signals to the display section 20 and the inversion control section 30. The inversion signal generation section generates the long-period inversion signal INV, and the inversion control section 30 generates the inversion control signal FRP2 and the vertical enable signal VEN2 based on the long-period inversion signal INV and the like. The RGB decoder section 13 generates the pixel signals VpixR, VpixG, and VpixB. The inversion section 14 controls an inversion operation on the pixel signals VpixR, VpixG, and VpixB in response to the inversion control signal FRP2 to output resultant signals as the pixel signals VpixR2, VpixG2, and VpixB2. The display section 20 performs display based on the pixel signals VpixR2, VpixG2, and VpixB2, the vertical enable signal VEN2, and the like.

### (Specific Operation of Display 1)

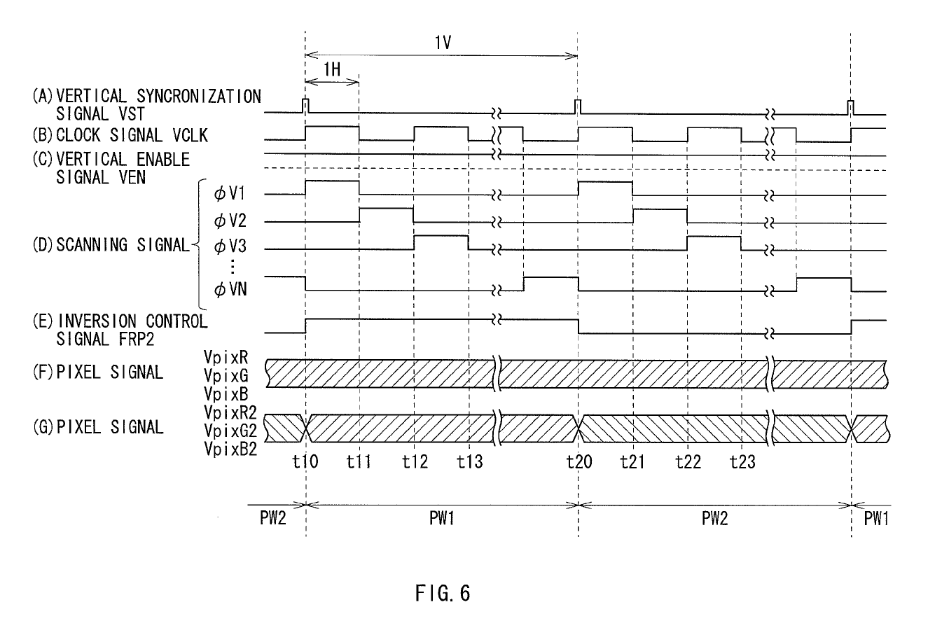

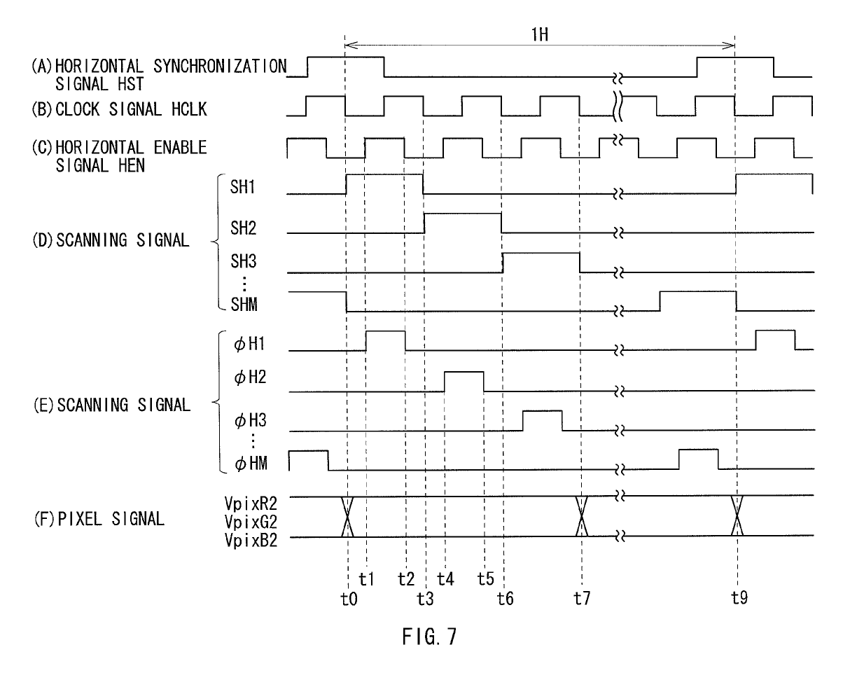

Next, referring to FIGS. 6 and 7, a specific operation of the display 1 will be described below.

FIG. 6 illustrates a timing waveform example of a display operation in the display 1, and a part (A) illustrates a waveform of the vertical synchronization signal VST, a part (B) illustrates a waveform of the clock signal VCLK, a part (C) illustrates a waveform of the vertical enable signal VEN, a part (D) illustrates waveforms of the scanning signals φV1 to φVN, a part (E) illustrates a waveform of the inversion control signal FRP2, a part (F) illustrates waveforms of the pixel signals VpixR, VpixG, and VpixB, and a part (G) illustrates waveforms of the pixel signals VpixR2, VpixG2, and VpixB2. It is to be noted that, in FIG. 6, the long-period inversion signal INV (not illustrated) is fixed at the low level or the high level.

FIG. 7 illustrates an example of a display operation in the display 1 in one horizontal period, and a part (A) illustrates a waveform of the horizontal synchronization signal HST, a part (B) illustrates a waveform of the clock signal HCLK, a part (C) illustrates a waveform of the horizontal enable signal HEN, a part (D) illustrates waveforms of the scanning signals SH1 to SHM, a part (E) illustrates waveforms of the scanning signals φH1 to φHM, and a part (F) illustrates waveforms of the pixel signals VpixR2, VpixG2, and VpixB2. In this example, the switches 23(1) to 23(M) are turned on when corresponding scanning signals φH1 to φHM are at the high level.

The display 1 alternately displays the first field image Fi1 and the second field image Fit every vertical period (1V). At this time, the pixel signals VpixR2, VpixG2, and VpixB2 are inverted every vertical period. The length of the vertical period is, for example, 16.7 [msec] (= 1/60 [Hz]). This operation will be described in detail below.

First, the timing control section 16 generates a pulse signal as the vertical synchronization signal VST around a timing t10 (refer to the part (A) in FIG. 6). Then, the vertical period (1V) starts. Moreover, at the timing t10, the timing control section 16 switches the clock signal VCLK from the low level to the high level (refer to the part (B) in FIG. 6). Then, the shift register of the vertical scanning section 26 samples a pulse part (a high-level part) of the vertical synchronization signal VST to switch the scanning signal φV1 from the low level to the high level (refer to the part (D) in FIG. 6). Therefore, in the display section 20, a first scanning signal line GCL is switched to the high level to select one horizontal line to be subjected to a display writing operation.

In one vertical period (1V) from the timing t10 to a timing t20, the RGB decoder section 13 supplies, to the inversion section 14, the pixel signals VpixR, VpixG, and VpixB for the first field image Fi1. Then, at the timing t10, the inversion control section 30 switches the inversion control signal FRP2 from the low level to the high level (refer to the part (E) in FIG. 6). Concurrently, the inversion section 14 outputs the pixel signals VpixR, VpixG, and VpixB for the first field image Fi1 supplied from the RGB decoder section 13 as it is as the pixel signals VpixR2, VpixG2, and VpixB2 (refer to the parts (F) and (G) in FIG. 6).

Then, in a period from the timing t10 to a timing t11 (one horizontal period (1H)), as illustrated in FIG. 7, the pixel signals Vpix2 are written into the sub-pixels SPix belonging to the one selected horizontal line.

More specifically, in FIG. 7, the timing control section 16 generates a pulse signal as the horizontal synchronization signal HST around a timing t0 (refer to the part (A) in FIG. 7). Then, at the timing t0, the timing control section 16 switches the clock signal HCLK from the high level to the low level (refer to the part (B) in FIG. 7); therefore, the shift register of the horizontal scanning section 21 samples a pulse part (a high-level part) of the horizontal synchronization signal HST to switch the scanning signal SH1 from the low level to the high level (refer to the part (D) in FIG. 7). Next, in a period from a timing t1 to a timing t2, the timing control section 16 switches the horizontal enable signal HEN to the high level (refer to the part (C) in FIG. 7). Therefore, in this period, the scanning signal φH1 is switched to the high level (refer to the part (E) in FIG. 7), and the switch 23(1) is turned on, and the pixel signal VpixR2 is applied to a first pixel signal line SGL to be supplied to the sub-pixel SPix belonging to the one selected horizontal line. Next, at a timing t3, the timing control section 16 switches the clock signal HCLK from the high level to the low level (refer to the part (B) in FIG. 7) to switch the scanning signal SH1 from the high level to the low level and to switch the scanning signal SH2 from the low level to the high level (refer to the part (D) in FIG. 7). Next, in a period from a timing t4 to a timing t5, the timing control section 16 switches the horizontal enable signal HEN to the high level (refer to the part (C) in FIG. 7). Therefore, in this period, the scanning signal φH2 is switched to the high level (refer to the part (E) in FIG. 7), and the switch 23(2) is turned on, and the pixel signal VpixG2 is applied to a second pixel signal line SGL to be supplied to the sub-pixel SPix belonging to the one selected horizontal line. Thus, in one horizontal period (1H) from the timing t0 to a timing t9, the pixel signals Vpix2 are supplied to and written into all of the sub-pixels SPix belonging to one selected horizontal line.

Next, at a timing t11, the timing control section 16 switches the clock signal VCLK from the high level to the low level (refer to the part (B) in FIG. 6). Therefore, in the shift register of the vertical scanning section 26, data is transferred to switch the scanning signal φV1 from the high level to the low level and to switch the scanning signal φV2 from the low level to the high level (refer to the part (D) in FIG. 6). Therefore, in the display section 20, a second scanning signal line GCL is switched to the high level to select one horizontal line to be subjected to a display writing operation, and in a period from the timing t11 to a timing t12, the pixel signals Vpix2 are written into respective sub-pixels SPix belonging to the one selected horizontal line.

After that, a similar operation is repeatedly performed until the timing t20 to sequentially select one horizontal line to be subjected to a display writing operation on a whole surface of the display section 20, thereby sequentially writing the pixel signals Vpix2 for the first field image Fi1 into respective sub-pixels SPix belonging to the selected one horizontal line. Thus, the first field image Fi1 is displayed on the whole surface of the display section 20.

Next, around the timing t20, the timing control section 16 generates a pulse signal as the vertical synchronization signal VST (refer to the part (A) in FIG. 6). Thus, the present vertical period (1V) is completed, and a subsequent vertical period starts. Moreover, at the timing t20, the timing control section 16 switches the clock signal VCLK from the low level to the high level (refer to the part (B) in FIG. 6). Therefore, the shift register of the vertical scanning section 26 samples a pulse part (a high-level part) of the vertical synchronization signal VST to switch the scanning signal φV1 from the low level to the high level (refer to the part (D) in FIG. 6). Therefore, in the display section 20, the first scanning signal line GCL is switched to the high level to select one horizontal line to be subjected to a display writing operation.

In one vertical period (1V) from the timing t20, the RGB decoder section 13 supplies, to the inversion section 14, the pixel signals VpixR, VpixG, and VpixB for the second field image Fi2. Then, at the timing t20, the inversion control section 30 switches the inversion control signal FRP2 from the high level to the low level (refer to the part (E) in FIG. 6). Concurrently, the inversion section 14 inverts the pixel signals VpixR, VpixG, and VpixB for the second field image Fi2 supplied from the RGB decoder section 13 to output resultant signals as the pixel signals VpixR2, VpixG2, and VpixB2 (refer to the parts (F) and (G) in FIG. 6). Then, in a period from the timing t20 to a timing t21, the pixel signals Vpix2 are written into respective sub-pixels SPix belonging to the one selected horizontal line.

Next, at the timing t21, the timing control section 16 switches the clock signal VCLK from the high level to the low level (refer to the part (B) in FIG. 6). Therefore, in the display section 20, the second scanning signal line GCL is switched to the high level to select one horizontal line to be subjected to a display writing operation, and in a period from the timing t21 to a timing t22, the pixel signals Vpix2 are written into respective sub-pixels SPix belonging to the one selected horizontal line.

After that, a similar operation is repeatedly performed to sequentially select one horizontal line to be subjected to a display writing operation on the whole surface of the display section 20, thereby sequentially writing the pixel signals Vpix2 for the second field image Fi2 into respective sub-pixels SPix belonging to the selected one horizontal line. Thus, the second field image Fi2 is displayed on the whole surface of the display section 20.

### (Specific Operations of Inversion Signal Generation Section 15 and Inversion Control Section 30)

Next, specific operations of the inversion signal generation section 15 and the inversion control section 30 will be described below.

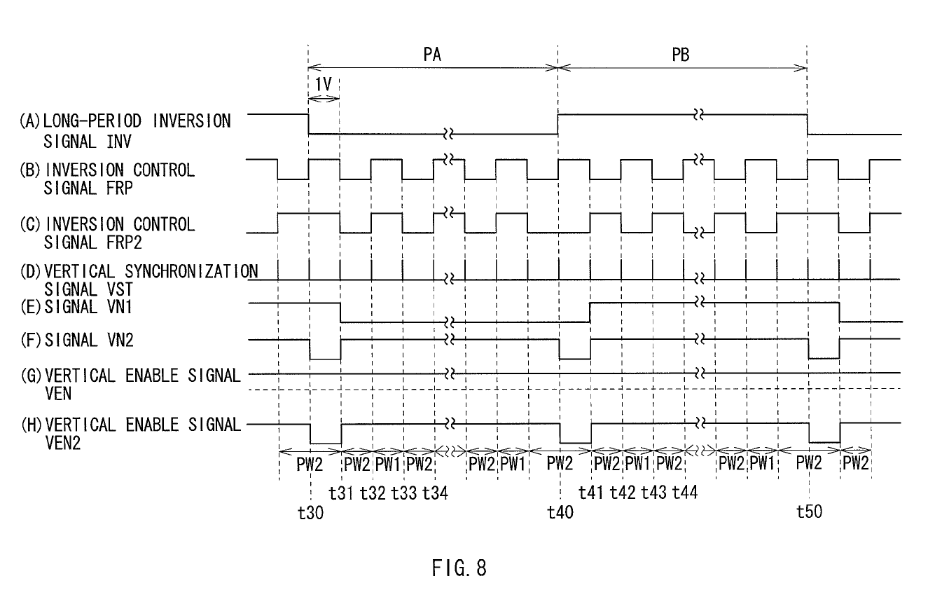

FIG. 8 illustrates an example of operations of the inversion signal generation section 15 and the inversion control section 30, and a part (A) illustrates a waveform of the long-period inversion signal INV, a part (B) illustrates a waveform of the inversion control signal FRP, a part (C) illustrates a waveform of the inversion control signal FRP2, a part (D) illustrates a waveform of the vertical synchronization signal VST, a part (E) illustrates a waveform of the signal VN1 (an output signal from the D-type flip-flop circuit 32), a part (F) illustrates a waveform of the signal VN2 (an output signal from the EX-NOR circuit 33), a part (G) illustrates a waveform of the vertical enable signal VEN, and a part (H) illustrates a waveform of the vertical enable signal VEN2.

In the display 1, two inversion periods PA and PB (a first period and a second period) are established based on the long-period inversion signal INV. The inversion section 14 performs an inversion operation on a pixel signal by a method differing between these two inversion periods PA and PB. Then, in each of the inversion periods PA and PB, the display section 20 alternately displays, every vertical period (1V), the first field image Fi1 and the second field image Fit based on the pixel signals Vpix2 supplied from the inversion section 14. This operation will be described in detail below.

The inversion signal generation section 15 switches the long-period inversion signal INV to the low level in a period from a timing t30 to a timing t40 (refer to the part (A) in FIG. 8). Accordingly, in this period (the inversion period PA), the EX-OR circuit 31 of the inversion control section 30 outputs, as the inversion control signal FRP2, a signal with the same level as that of the inversion control signal FRP (refer to the part (B) in FIG. 8) supplied from the timing control section 16 (refer to the part (C) in FIG. 8). Moreover, the inversion signal generation section 15 switches the long-period inversion signal INV to the high level in a period from the timing t40 to a timing t50 (refer to the part (A) in FIG. 8). Accordingly, in this period (the inversion period PB), the EX-OR circuit 31 of the inversion control section 30 outputs, as the inversion control signal FRP2, an inverted signal of the inversion control signal FRP (refer to the part (B) in FIG. 8) supplied from the timing control section 16 (refer to the part (C) in FIG. 8). As a result, in adjacent vertical periods with a border between the inversion period PA and the inversion period PB in between, the inversion control signal FRP2 is at the same level.

The inversion section 14 performs an inversion control on the pixel signals VpixR, VpixG, and VpixB supplied from the RGB decoder 13 in response to the inversion control signal FRP2 generated in such a manner to output resultant signals as the pixel signals VpixR2, VpixG2, and VpixB2. More specifically, in the case where the inversion control signal FRP2 is at the high level, the inversion section 14 outputs the pixel signals VpixR, VpixG, and VpixB as it is as the pixel signals VpixR2, VpixG2, and VpixB2, and in the case where the inversion control signal FRP2 is at the low level, the inversion section 14 inverts the pixel signals VpixR, VpixG, and VpixB to output resultant signals as the pixel signals VpixR2, VpixG2, and VpixB2. In other words, an inversion operation method differs between the inversion period PA and the inversion period PB.

Moreover, the D-type flip-flop circuit 32 of the inversion control section 30 samples the long-period inversion signal INV (refer to the part (A) in FIG. 8) at timings in synchronization with a rising edge of the vertical synchronization signal VST (refer to the part (D) in FIG. 8) in both of the inversion periods PA and PB. At this time, although not illustrated, around the timing t30, after the vertical synchronization signal VST rises, the long-period inversion signal INV falls, and around the timing t40, after the vertical synchronization signal VST rises, the long-period inversion signal INV rises. Therefore, the D-type flip-flop circuit 32 outputs the signal VN1 which is the long-period inversion signal INV delayed by one vertical period (1V) (refer to the parts (A) and (E) in FIG. 8). In other words, the D-type flip-flop circuit 32 functions as a delay circuit delaying the long-period inversion signal INV by one vertical period (1V). The EX-NOR circuit 33 determines an inverted signal of an exclusive OR of the long-period inversion signal INV (refer to the part (A) in FIG. 8) and the signal VN1 (refer to the part (E) in FIG. 8) to output the inverted signal as the signal VN2 (refer to the part (F) in FIG. 8). The signal VN2 is a signal which is at the low level only in a first vertical period in both of the inversion periods PA and PB and is at the high level in other periods. The AND circuit 34 determines an AND of the vertical enable signal VEN (refer to the part (G) in FIG. 8) and the signal VN2 (refer to the part (F) in FIG. 8) to output a resultant signal as the vertical enable signal VEN2. The vertical enable signal VEN2 is a signal which is at the low level only in the first vertical period in both of the inversion periods PA and PB and is at the same level as that of the vertical enable signal VEN in other periods.

In the display section 20, writing of the pixel signals Vpix2 into the sub-pixels SPix is controlled based on the vertical enable signal VEN2. More specifically, in the case where the vertical enable signal VEN2 is at the high level, line-sequential scanning is performed in the display section 20, and the pixel signals Vpix2 are written into the sub-pixels SPix from one horizontal line to another. On the other hand, in the case where the vertical enable signal VEN2 is at the low level, all of the scanning signals φV1 to φVN are switched to the low level; therefore, TFT devices Tr of all sub-pixels SPix are turned off, and writing of the pixel signals Vpix2 into the sub-pixels SPix are not performed accordingly.

In other words, in the first vertical period in each of the inversion periods PA and PB, the vertical enable signal VEN2 is switched to the low level; therefore, writing into the sub-pixels SPix is not performed throughout a display screen. Therefore, in this period, in each of the sub-pixels SPix, the TFT device Tr is turned off, thereby substantially maintaining the pixel potential Vp.

Therefore, the display 1 alternately displays the first field image Fi1 (a first field image display period PW1) and the second field image Fi2 (a second field image display period PW2) every vertical period (1V), except for the first vertical period in each of the inversion periods PA and PB.

Next, functions of the inversion signal generation section 15 and the inversion control section 30 will be described referring to specific examples.

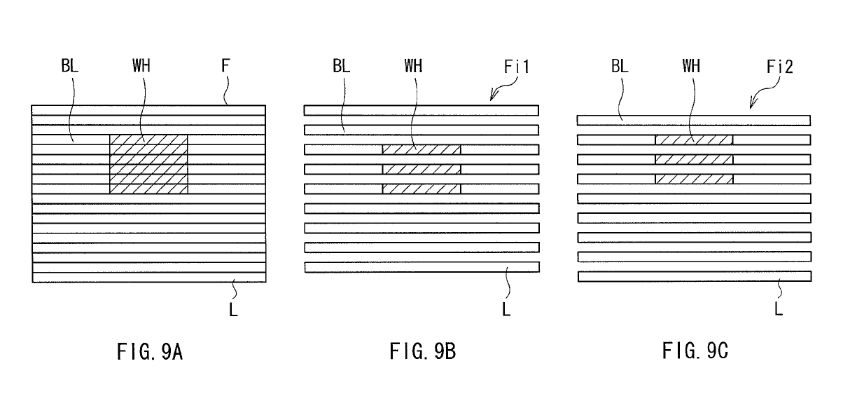

FIGS. 9A to 9C schematically illustrate an example of an interlaced image, and FIGS. 9A, 9B, and 9C illustrate the frame image F, the first field image Fi1, and the second field image Fi2, respectively. In this example, the display 1 displays a still image. In FIGS. 9A to 9C, shaded regions are regions displaying white (WH), and other regions are regions displaying black (BL).

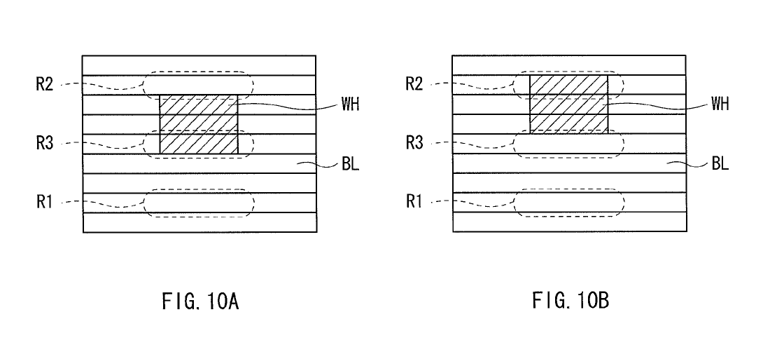

FIGS. 10A and 10B illustrate display of an image in the display section 20, and FIG. 10A illustrates the case where the first field image Fi1 illustrated in FIG. 9B is displayed, and FIG. 10B illustrates the case where the second field image Fi2 illustrated in FIG. 9C is displayed. In the display 1, the field images Fi1 and Fi2 illustrated in FIGS. 10A and 10B are alternately displayed, and at this time, in a region R2, black is displayed when the first field image Fi1 is displayed (refer to FIG. 10A), and white is displayed when the second field image Fi2 is displayed (refer to FIG. 10B). Moreover, in a region R3, white is displayed when the first field image Fi1 is displayed (refer to FIG. 10A), and black is displayed when the second field image Fi2 is displayed (refer to FIG. 10B).

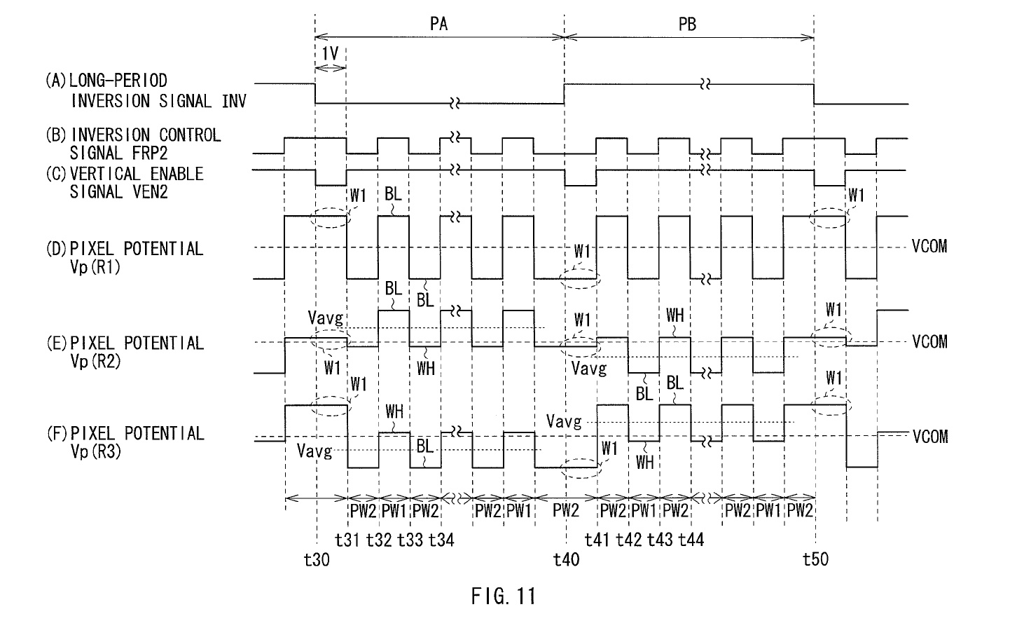

FIG. 11 illustrates an example of a display operation in the display 1 in the case where display is performed as illustrated in FIGS. 10A and 10B, and a part (A) illustrates a waveform of the long-period inversion signal INV, a part (B) illustrates a waveform of the inversion control signal FRP2, a part (C) illustrates a waveform of the vertical enable signal VEN2, and parts (D) to (F) illustrate waveforms of pixel potentials Vp. In FIG. 11, the part (D) illustrates a pixel potential Vp(R1) in the sub-pixels SPix of the region R1 where black is consistently displayed, the part (E) illustrates a pixel potential Vp(R2) in the sub-pixels SPix of the region R2, and the part (F) illustrates a pixel potential Vp(R3) in the sub-pixels SPix of the region R3. It is to be noted that, in FIG. 11, timings t30 to t50 correspond to timings t30 to t50 in FIG. 8, respectively.

In the sub-pixels SPix in the region R1 where black is consistently displayed, as illustrated in the part (D) in FIG. 11, the pixel signals VPix2 for each of the field image Fi1 and Fi2 are supplied by an inversion drive in response to the inversion control signal FRP2 (refer to the part (B) in FIG. 11). At this time, as the sub-pixels SPix display the same color in the first field image Fi1 and the second field image Fi2, the pixel potential Vp has an AC waveform with reference to the common voltage VCOM as its center (refer to the part (D) in FIG. 11). In other words, a time average value of the pixel potential Vp is equal to the common voltage VCOM.

In the sub-pixels SPix in the regions R2 and R3, a writing operation is performed by an inversion drive in response to the inversion control signal FRP2 in a similar manner. As illustrated in FIGS. 10A and 10B, unlike the sub-pixels SPix in the region R1, these sub-pixels SPix display colors differing between the first field image Fi1 and the second field image Fi2; therefore, a time average value Vavg of the pixel potential Vp is not equal to the common voltage VCOM. More specifically, the pixel potential Vp of the sub-pixels SPix in the region R2 becomes a potential corresponding to black display in the first field display period PW1 and a potential corresponding to white display in the second field display period PW2; therefore, as illustrated in the part (E) in FIG. 11, the time average value Vavg is higher than the common voltage VCOM in the inversion period PA and lower than the common voltage VCOM in the inversion period PB. Moreover, the pixel potential Vp of the sub-pixels SPix in the region R3 becomes a potential corresponding to white display in the first field display period PW1 and a potential corresponding to black display in the second field display period PW2; therefore, as illustrated in the part (F) in FIG. 11, the time average value Vavg is lower than the common voltage VCOM in the inversion period PA and higher than the common voltage VCOM in the inversion period PB.

However, the time average value Vavg of the pixel potential VP in the inversion period PA and the time average value Vavg of the pixel potential Vp in the inversion period PB have an inversion relation with reference to the common voltage VCOM; therefore, in the total period of the inversion period PA and the inversion period PB, the time average value of the pixel potential Vp is equal to the common voltage VCOM.

Thus, in the display 1, the inversion periods PA and PB in which an inversion operation is performed by a method differing therebetween are provided; therefore, as illustrated in the parts (D) to (F) in FIG. 11, the time average value of the pixel potential Vp in the total period of the inversion period PA and the inversion period PB is allowed to be equal to the common voltage VCOM, thereby reducing so-called “burn-in” in the liquid crystal display.

Moreover, as described above, in the first vertical period in each of the inversion periods PA and PB, the vertical enable signal VEN2 is switched to the low level to switch voltages (the scanning signals φV1 to φVN) of all scanning signal lines GCL to the low level. Therefore, in the sub-pixels SPix, the TFT devices Tr are turned off, and an writing operation into the sub-pixels SPix is not performed; therefore, as illustrated in the parts (D) to (F) in FIG. 11, the pixel potential Vp maintains a potential in a previous vertical period (a waveform part W1). Thus, as will be described later referring to a comparative example, distortion of a display image when the long-period inversion signal INV is inverted is allowed to be reduced, and image quality is allowed to be improved.

### COMPARATIVE EXAMPLE

Next, functions of the embodiment will be described in contrast with the comparative example. In the comparative example, a writing operation into the sub-pixels SPix is also performed in the first vertical period in each of the inversion periods PA and PB.

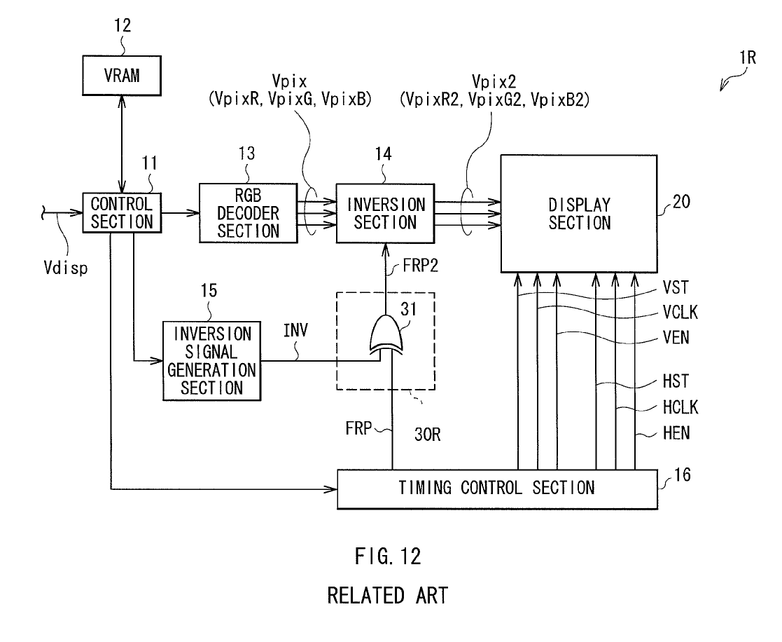

FIG. 12 illustrates a configuration example of a display 1R according to the comparative example. The display 1R includes an inversion control section 30R. The inversion control section 30R is equivalent to the inversion control section 30 (refer to FIG. 3) not including the D-type flip-flop circuit 32, the EX-NOR circuit 33, and the AND circuit 34. Therefore, in the comparative example, the vertical enable signal VEN generated in the timing control section 16 is supplied to the display section 20 as it is.

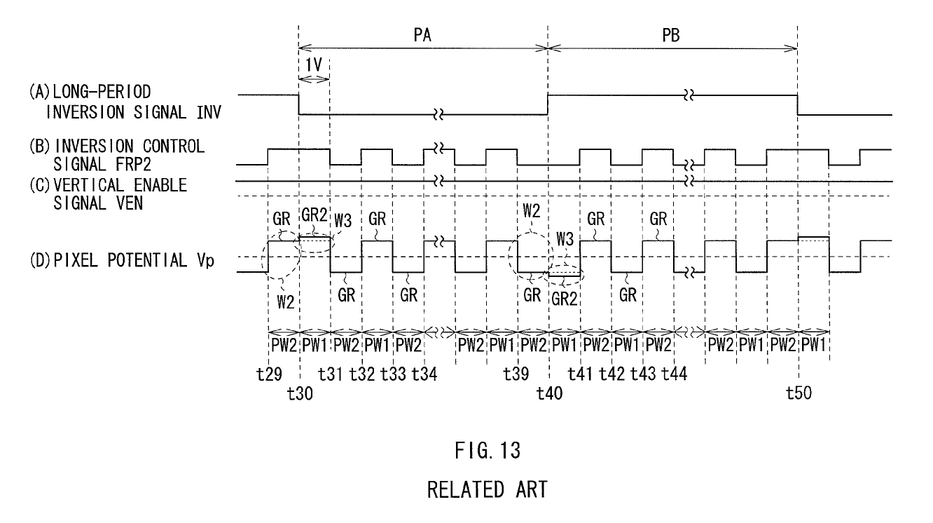

FIG. 13 illustrates an example of a display operation in the display 1R, and a part (A) illustrates a waveform of the long-period inversion signal INV, a part (B) illustrates a waveform of the inversion control signal FRP2, a part (C) illustrates a waveform of the vertical enable signal VEN2, and a part (D) illustrates a waveform of the pixel potential Vp in the sub-pixel SPix consistently displaying a predetermined halftone color. It is to be noted that, in FIG. 11, timings t30 to t50 correspond to the timings t30 to t50 in FIG. 8, respectively.

As illustrated in FIG. 13, in the display 1R according to the comparative example, in the first vertical period in each of the inversion periods PA and PB, the vertical enable signal VEN is at the high level; therefore, the pixel signals Vpix2 are written into the sub-pixels SPix in this period. At this time, in adjacent vertical periods with the border between the inversion period PA and the inversion period PB in between, the pixel signals Vpix2 with an equal voltage is successively applied.

However, in reality, the pixel potentials Vp in the two vertical periods may not be equal to each other. In other words, in the case where, at a timing t29, t39 or the like, the pixel signals Vpix2 are inverted to be supplied to the sub-pixels SPix, a charge amount charged into the liquid crystal devices LC is large; therefore, the inversion section 14 is not allowed to sufficiently drive the sub-pixels SPix, and the pixel potential Vp may not be switched to a sufficient level (a waveform part W2). On the other hand, in the case where the pixel signals Vpix2 are applied as it is without inversion at the timing t30, t40 or the like, the charge amount charged into the liquid crystal devices LC is small; therefore, the inversion section 14 is allowed to sufficiently drive the sub-pixels SPix, and the pixel potential Vp is allowed to be switched to a level close to a desired potential (a waveform part W3). Therefore, for example, in the case where the display 1R displays the halftone color throughout the display screen, when the long-period inversion signal INV (refer to the part (A) in FIG. 13) is inverted, luminance of the whole screen instantaneously varies. In other words, in the case where the long-period inversion signal INV which is logic-inverted at intervals of approximately 1 minute is used, such a phenomenon occurs at intervals of approximately 1 minute to cause a decline in image quality.

On the other hand, in the display 1 according to the embodiment, in the first vertical period in each of the inversion periods PA and PB, a writing operation of the pixel signals Vpix2 into the sub-pixels SPix is not performed. Therefore, in adjacent vertical periods with the border between the inversion period PA and the inversion period PB in between, the pixel potential Vp is maintained, and the pixel potentials Vp in the adjacent vertical periods with the border between the inversion period PA and the inversion period PB in between become equal to each other accordingly. Therefore, for example, even in the case where the display 1 displays the halftone color throughout the display screen, a possibility that luminance of the whole screen instantaneously varies when the long-period inversion signal INV is inverted is allowed to be reduced, and a decline in image quality is allowed to be suppressed.

### [Effects]

As described above, in the embodiment, in the first vertical period in each of the inversion periods PA and PB, a writing operation of the pixel signals into the sub-pixels SPix is not performed; therefore, a decline in image quality is allowed to be suppressed.

### Modification 1-1

In the above-described embodiment, in the first vertical periods in the inversion periods PA and PB, the TFT devices Tr of the sub-pixels SPix are turned off not to perform the writing operation of the pixel signals Vpix2; however, the technology is not limited thereto, and in addition to the TFT devices Tr of the sub-pixels SPix, the switches 23(1) to 23(M) may be turned off not to apply the pixel signals Vpix2 to the pixel signal lines SGL. A specific example will be described below.

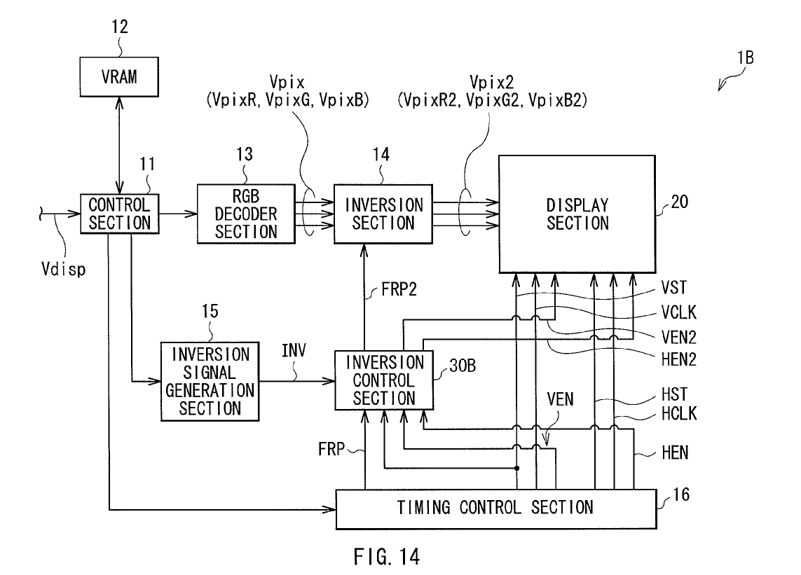

FIG. 14 illustrates a configuration example of a display 1B according to the modification. The display 1B includes an inversion control section 30B. The inversion control section 30B also has a function of generating a horizontal enable signal HEN2 based on the horizontal enable signal HEN in addition to the function of the inversion control section 30 in the above-described embodiment. Then, the horizontal enable signal HEN2 generated by the inversion control section 30B is supplied to the display section 20.

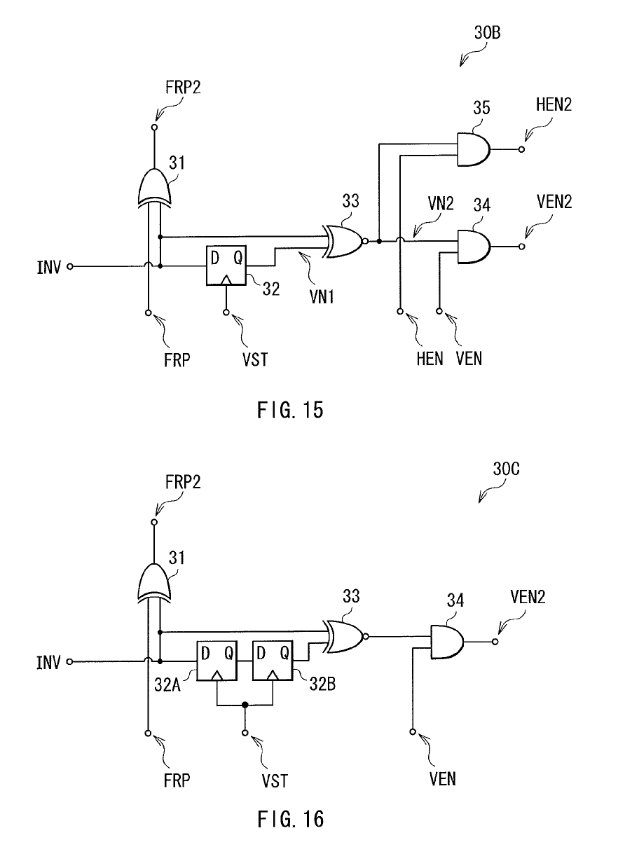

FIG. 15 illustrates a configuration example of the inversion control section 30B. The inversion control section 30B includes an AND circuit 35. The AND circuit 35 determines an AND of an output signal (the signal VN2) from the EX-NOR circuit 33 and the horizontal enable signal HEN to output a resultant signal as the horizontal enable signal HEN2.

In this configuration, the inversion control section 30B generates the horizontal enable signal HEN2 which is switched to the low level in a first vertical period after the long-period inversion signal INV is switched and is switched to a signal with the same level as that of the horizontal enable signal HEN in other periods. Thus, in the first vertical period after the long-period inversion signal INV is switched (the first vertical periods in the inversion periods PA and PB), the switches 23(1) to 23(M) are turned off; therefore, the pixel signals Vpix2 are not applied to the pixel signal lines SGL.

It is to be noted that, in this example, the switches 23(1) to 23(M) are turned off; however, for example, a similar switch may be included in the inversion section 14, and the switch may be turned off in the first vertical period after the long-period inversion signal INV is switched, thereby not applying the pixel signals VpixR2, VpixG2, and VpixB2 to the display section 20.

### Modification 1-2

In the above-described embodiment, in the inversion control section 30, the long-period inversion signal INV is delayed by one vertical period (1V); however, the technology is not limited thereto, and the long-period inversion signal INV may be delayed by a plurality of vertical periods. The case where the long-period inversion signal INV is delayed by two vertical periods will be described below as an example.

FIG. 16 illustrates a configuration example of an inversion control section 30C according to the modification. The inversion control section 30C includes D-type flip-flop circuits 32A and 32B. The long-period inversion signal INV and the vertical synchronization signal VST are supplied to a data input terminal and a clock input terminal of the D-type flip-flop circuit 32A, respectively. A data input terminal of the D-type flip-flop circuit 32B is connected to an output terminal of the D-type flip-flop circuit 32A, and the vertical synchronization signal VST is supplied to a clock input terminal of the D-type flip-flop circuit 32B. An output signal from the D-type flip-flop circuit 32B is supplied to the EX-NOR circuit 33. A combination of the D-type flip-flop circuits 32A and 32B functions as a delay circuit delaying the long-period inversion signal INV by a period being twice as long as one vertical period (1V). Therefore, in the display including the inversion control section 30C, in first two vertical periods in each of the inversion periods PA and PB, the writing operation of the pixel signals into the sub-pixels SPix is not allowed to be performed, and as in the case of the above-described embodiment, a decline in image quality is allowed to be suppressed.

### 2. Second Embodiment

Next, a display 2 according to a second embodiment will be described below. In the embodiment, the lengths of the inversion periods PA and PB are adjustable based on the image signal Vdisp. It is to be noted that like components are denoted by like numerals as of the display 1 according to the first embodiment and will not be further described.

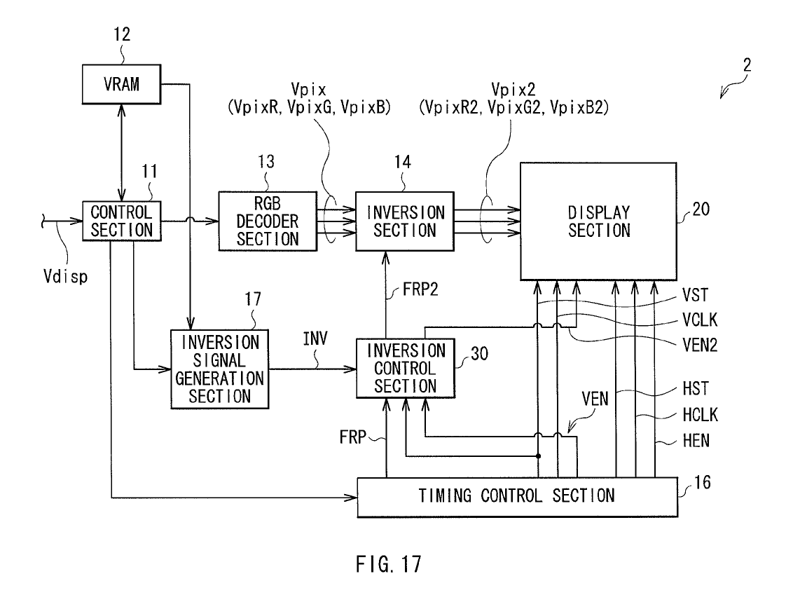

FIG. 17 illustrates a configuration example of the display 2 according to the embodiment. The display 2 includes an inversion signal generation section 17. The inversion signal generation section 17 adjusts an inversion interval of the long-period inversion signal INV based on a field image stored in the VRAM 12.

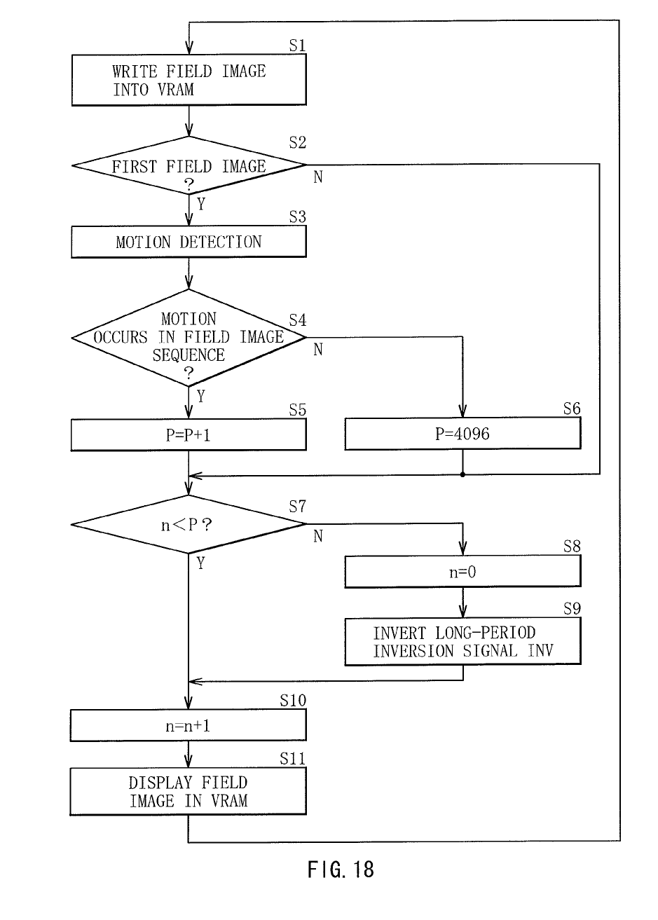

FIG. 18 illustrates a flow chart of an operation in the display 2. In the display 2, when motion does not occur in an image sequence, the inversion interval of the long-period inversion signal INV is adjusted to a predetermined minimum period, and when motion occurs in the image sequence, the inversion interval is adjusted to a longer period. The inversion interval of the long-period inversion signal INV is determined by a variable P using the length of a vertical period as a unit. Then, after the long-period inversion signal INV is inverted, a variable n is incremented every vertical period from 0, and when the variable n becomes equal to the variable P, the long-period inversion signal INV is inverted. Such inversion will be described in detail below.

First, the control section 11 writes a field image included in the supplied image signal Vdisp into the VRAM 12 (step S1).

Next, the control section 11 confirms whether the field image written into the VRAM 12 is the first field image (step S2). In the case where the field image is the first field image, the operation proceeds to step S3, and in the case where the field image is not the first field image, the operation proceeds to step S7.

In the step S2, in the case where the field image written into the VRAM 12 is the first field image, the inversion signal generation section 17 performs motion detection based on the first field image stored in the VRAM 12 (step S3). The motion detection is allowed to be performed by, for example, optical flow calculation. As an optical flow calculation algorithm, for example, a Horn-Schunck method is applicable. The Horn-Schunck method is described in, for example, “Berthold K. P. Horn and Brian G. Schunck Determining Optical Flow, Artificial Intelligence, Vol. 17, pp. 185-203, August 1981”.

Next, the inversion signal generation section 17 detects whether motion occurs in a field image sequence based on a motion detection result in the step S3 (step S4). In the step S4, in the case where motion in the field image sequence is detected, the inversion signal generation section 17 increments the variable P (step S5). Moreover, in the step S4, in the case where motion in the field image sequence is not detected, the inversion signal generation section 17 adjusts the variable P to 4096 (step S6).

Next, the inversion signal generation section 17 confirms whether the variable n is smaller than the variable P (step S7). In the case where the variable n is smaller than the variable P, the operation proceeds to step S10, and in the case where the variable n is equal to or larger than the variable P, the operation proceeds to step S8.

In the step S7, in the case where the variable n is equal to or larger than the variable P, the inversion signal generation section 17 adjusts the variable n to 0 (resets the variable n) (step S8) to invert the long-period inversion signal INV (step S9).

Next, the inversion signal generation section 17 increments the variable n (step S10).

Next, the display 2 performs display based on the field image stored in the VRAM 12 (step S11).

Then, the operation returns to the step S1, and the display 2 repeats the above operation.

In the display 2, motion detection is performed on the field image sequence, and a possibility of occurrence of burn-in when the display section 20 displays the field image is determined based on whether motion occurs in the field image sequence. Then, when it is determined that there is the possibility of occurrence of burn-in, the variable P is adjusted to a smaller value to reduce the possibility of occurrence of burn-in, and in the case where it is determined that the possibility of occurrence of burn-in caused by displaying the field image is low, the variable P is adjusted to a larger value to suppress a decline in image quality.

More specifically, in the case where the inversion signal generation section 17 does not detect motion in the field image sequence, the variable P is adjusted to 4096 (step S6). In other words, in this case, the inversion signal generation section 17 determines that burn-in may occur in the display section 20, because the display section 20 displays the field image sequence in which motion does not occur, and adjusts, to a minimum value (4096 in this example), the variable P corresponding to the inversion intervals of the long-period inversion signal INV. It is to be noted that, for example, in the case where field images are displayed at a field rate of 60 [Hz], the inversion interval of the long-period inversion signal INV is 68.2 [sec] (=4096/60 [Hz]). Thus, in the case where motion does not occur in the field image sequence, the display 2 adjusts the variable P to the minimum value to perform switching of the inversion period PA and the inversion period PB with high frequency. Therefore, in the display 2, the possibility of occurrence of burn-in on the display section 20 is allowed to be reduced.

Moreover, in the case where motion in the field image sequence is detected, the inversion signal generation section 17 increments the variable P (step S5). In other words, in this case, the inversion signal generation section 17 determines that the possibility of occurrence of burn-in on the display section 20 is low, because the display section 20 displays the field image sequence in which motion occurs; therefore, the variable P corresponding to the inversion interval of the long-period inversion signal INV is incremented. Thus, when motion occurs in the field image sequence, the display 2 adjusts the variable P to a larger value to reduce switching frequency of the inversion period PA and the inversion period PB. Therefore, in the display 2, even if a display image is slightly distorted when the long-period inversion signal INV is inverted, distorted images are less often displayed; therefore, a decline in image quality is allowed to be reduced.

Moreover, the display 2 performs motion detection only in the case where the field image written into the VRAM 12 is the first field image Fi1 (steps S2 and S3). Therefore, in the steps S3 and S4, motion detection is allowed to be performed with higher accuracy. In other words, for example, in the case where motion detection is performed based on both the first field image Fi1 and the second field image Fi2, in the motion detection in the step S3, motion caused by a difference between the first field image Fi1 and the second field image Fi2 may be detected. On the other hand, in the case where motion detection is performed based on only the first field image Fi1, a possibility of such a detection error is allowed to be reduced; therefore, motion in the field image sequence is allowed to be detected with higher accuracy. It is to be noted that, in this example, motion detection is performed only in the case where the field image written into the VRAM 12 is the first field image Fi1; however, the technology is not limited thereto, and motion detection may be performed only in the case where the field image written into the VRAM 12 is the second field image Fit.

Thus, in the embodiment, the lengths of the inversion periods PA and PB are adjusted based on a result of detecting motion in the field image sequence; therefore, burn-in is allowed to be reduced, and a decline in image quality is allowed to be suppressed.

Moreover, in the embodiment, in the case where motion in the field image sequence is not detected, the inversion interval of the long-period inversion signal is adjusted to a predetermined minimum value to perform switching of the inversion period PA and the inversion period PB with high frequency; therefore, burn-in on the display section is allowed to be reduced.

Further, in the embodiment, in the case where motion in the field image sequence is detected, the inversion interval of the long-period inversion signal INV is adjusted to become longer, thereby allowing the switching frequency of the inversion period PA and the inversion period PB to become lower; therefore, even in the case where the display image is slightly distorted when the long-period inversion signal is inverted, a decline in image quality is allowed to be suppressed.

Other effects are similar to those in the first embodiment.

### Modification 2-1

In the above-described embodiment, the possibility of occurrence of burn-in is determined based on whether motion occurs in the field image sequence; however, the technology is not limited thereto, and the possibility of occurrence of burn-in may be determined based on whether the proportion of a region where motion occurs in a whole field image is equal to or larger than a predetermined value, or based on whether the amount of change of pixel information for each pixel of the field image is equal to or larger than a predetermined amount.

### Other Modifications

In the second embodiment, as in the case of Modification 1-1 of the first embodiment, in first vertical periods in the inversion periods PA and PB, the switches 23(1) to 23(M) may be turned off, in addition to the TFT devices Tr of the sub-pixels SPix, or as in the case of Modification 1-2 of the first embodiment, in the inversion control section 30, the long-period inversion signal INV may be delayed by a plurality of vertical periods.

### 3. Third Embodiment

Next, a display 3 according to a third embodiment will be described below. The display 3 according to the third embodiment is similar to the display 2, except that motion detection is not performed when an OSD (On Screen Display) image is displayed. It is to be noted that like components are denoted by like numerals as of the display 2 according to the second embodiment and will not be further described.

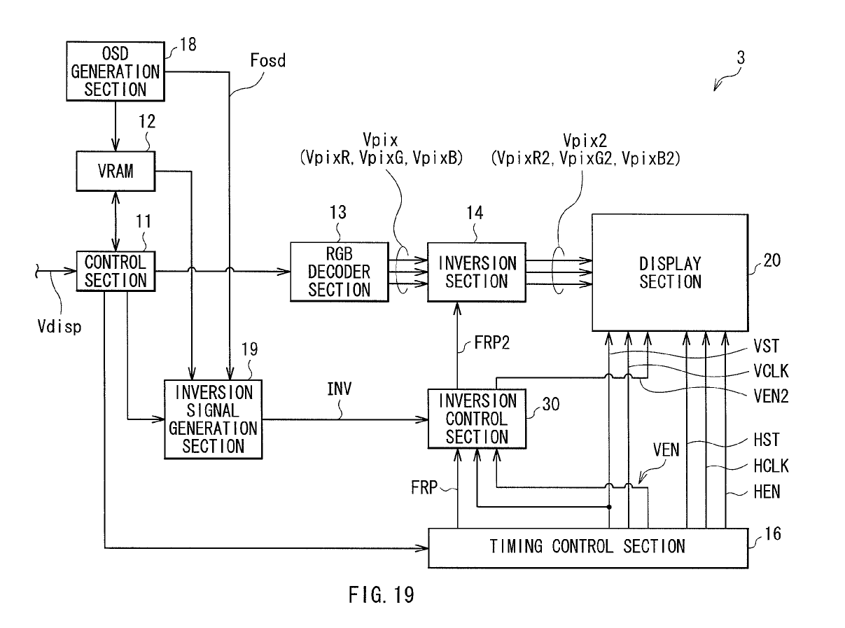

FIG. 19 illustrates the display 3 according to the embodiment. The display 3 includes an OSD generation section 18 and an inversion signal generation section 19.

The OSD generation section 18 generates an OSD image. The OSD image generated in the OSD generation section 18 is superimposed on the field images in the VRAM 12, and the field images on which the OSD image is superimposed are displayed on the display section 20. Moreover, the OSD generation section 18 generates an OSD flag signal Fosd indicating whether the OSD image is superimposed on the field images.

The inversion signal generation section 19 performs motion detection based on the field images stored in the VRAM and the OSD flag signal Fosd to adjust the inversion interval of the long-period inversion signal INV.

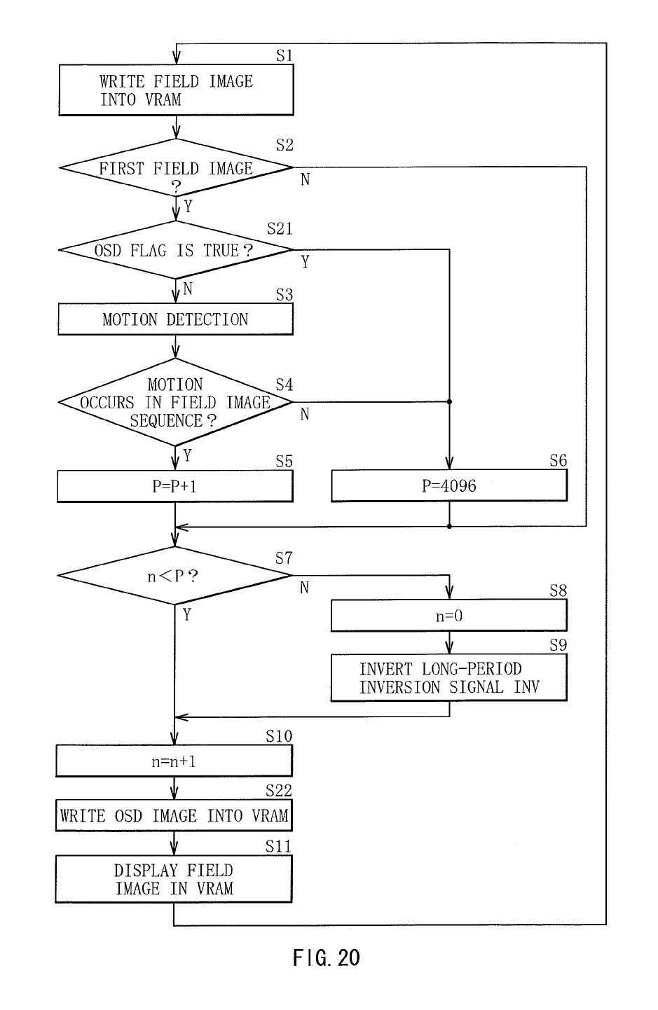

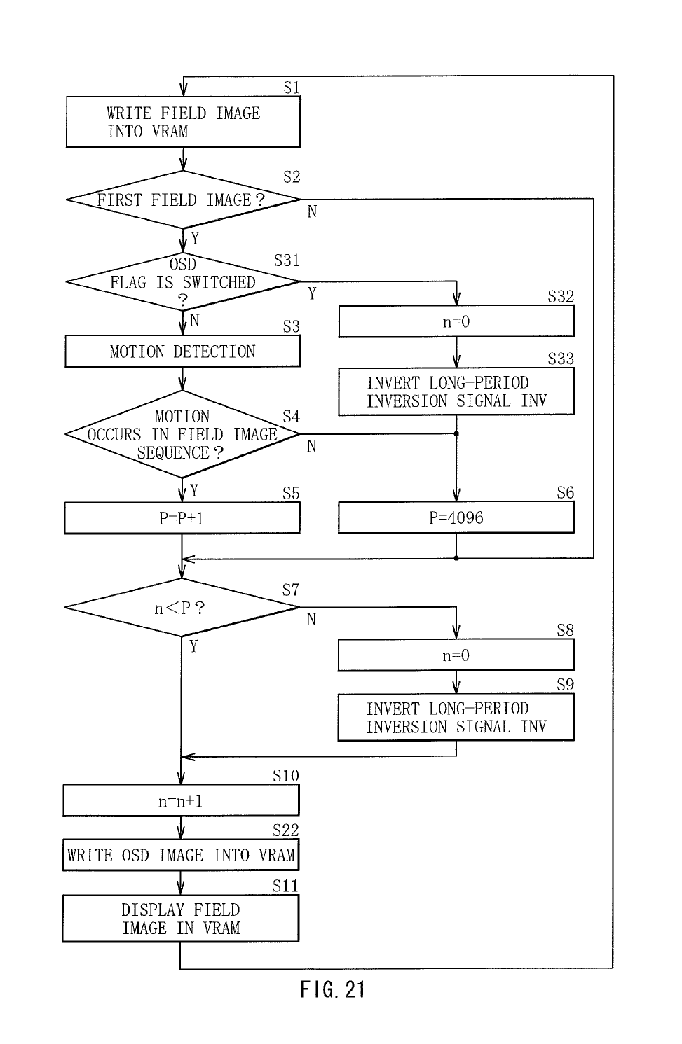

FIG. 20 illustrates a flow chart of an operation in the display 3. It is to be noted that the same steps as those in the flow chart (refer to FIG. 18) in the display 2 according to the second embodiment will not be further described.

In the step S2, in the case where the field image written into the VRAM 12 is the first field image, the inversion signal generation section 19 detects whether the OSD flag signal Fosd supplied from the OSD generation section 18 is true (step S21). In the case where the OSD flag signal Fosd is true, the operation proceeds to the step S6, and in the case where the OSD flag signal Fosd is not true, the operation proceeds to the step S3.

Moreover, next to the step S10, the OSD generation section 18 writes the generated OSD image into the VRAM 12 (step S22). Therefore, in the VRAM 12, the OSD image is superimposed on the stored field images.

In the display 3, whether motion detection is performed is determined based on the OSD flag signal Fosd. Typically, the OSD image is a still image; therefore, in the case where the display section 20 displays the OSD image, burn-in may occur on the display section 20. Therefore, in the case where the OSD flag signal Fosd is true, the inversion signal generation section 19 determines, without performing motion detection, that burn-in may occur on the display section 20, thereby adjusting, to the minimum value (4096 in this example), the variable P corresponding to the inversion interval of the long-period inversion signal INV. Thus, as in the case of the second embodiment and the like, the possibility of occurrence of burn-in is allowed to be reduced.

Thus, in the embodiment, in the case where the OSD flag signal Fosd is true, motion detection is not performed; therefore, a circuit operation load is allowed to be reduced. Other effects are similar to those in the first embodiment.

### Modification 3-1]

In the above-described embodiment, motion detection is performed based on whether the OSD flag signal Fosd is true; however, the technology is not limited thereto, and motion detection may be performed in response to, for example, switching of the OSD flag signal Fosd. Such an operation will be described in detail below.

FIG. 21 illustrates a flow chart of an operation in a display 3B according to the modification. It is to be noted that the same steps as those in the flow chart (refer to FIG. 20) of the display 3 according to the embodiment will not be further described.

In the step S2, in the case where the field image written into the VRAM 12 is the first field image, an inversion signal generation section 19B according to the modification detects whether the OSD flag signal Fosd supplied from the OSD generation section 18 is switched (step S31). In the case where the OSD flag signal Fosd is switched, the operation proceeds to step S32, and in the case where the OSD flag signal Fosd is not switched, the operation proceeds to step S3.

In the step S31, in the case where switching of the OSD flag signal Fosd is detected, the inversion signal generation section 19B adjusts the variable n to 0 (rests the variable n) (step S32) to invert the long-period inversion signal INV (step S33). Then, the operation proceeds to the step S6.

Thus, in the display 3B, when the OSD flag signal Fosd is switched, the long-period inversion signal INV is inverted to start next inversion periods PA and PB; therefore, the possibility of occurrence of burn-in on the display section 20 is allowed to be reduced. More specifically, for example, after the OSD flag signal Fosd is switched from False to True, burn-in caused by the OSD image (a still image) may occur on the display section 20; however, when, at a timing when the OSD flag signal Fosd is switched from False to True, the long-period inversion signal INV is inverted and the variable P is adjusted to the minimum value (step S6), the possibility of occurrence of burn-in in a period where the OSD image is displayed is allowed to be reduced. Moreover, for example, when the OSD flag signal Fosd is switched from True to False, the long-period inversion signal INV is inverted, and the variable P is adjusted to the minimum value (step S6); therefore, a state in the period where the OSD image has been displayed is allowed to be reset, and the possibility of occurrence of burn-in is allowed to be reduced.

It is to be noted that, in this example, when the OSD flag signal Fosd is switched, the long-period inversion signal INV is inverted; however, the technology is not limited thereto, and, for example, the long-period inversion signal INV may be inverted, only when the OSD flag signal Fosd is switched from False to True.

### Other Modifications

In the third embodiment, as in the case of Modification 2-1 of the second embodiment, for example, the possibility of occurrence of burn-in may be determined based on whether the proportion of a region where motion occurs in a whole field image is equal to or larger than a predetermined value, or based on whether the amount of change of pixel information for each pixel of the field image is equal to or larger than a predetermined amount.

Although the present technology is described referring to the embodiments and modifications, the technology is not limited thereto, and may be variously modified.

For example, in the second and third embodiments, as in the case of Modification 1-1 of the first embodiment, in the first vertical periods in the inversion periods PA and PB, in addition to the TFT device Tr of the sub-pixel SPix, the switches 23(1) to 23(M) may be turned off, and as in the case of Modification 1-2 of the first embodiment, in the inversion control section 30, the long-period inversion signal INV may be delayed by a plurality of vertical periods.

Moreover, for example, in the above-described embodiments and the like, the horizontal scanning section is provided, and in a 1H period, scanning is performed in a horizontal direction to write the pixel signal Vpix2 into the pixel Pix; however, the technology is not limited thereto, and, for example, in the 1H period, the pixel signal Vpix2 may be concurrently written into a plurality of pixels Pix belonging to the selected horizontal line.

It is to be noted that the technology is allowed to have the following configurations.

(1) A drive circuit for display, the drive circuit including:

a pixel signal generation section generating a pixel signal and supplying the pixel signal to a display section, the pixel signal being inverted every frame period in each of a first period and a second period, the first period and the second period being alternately provided; and

a writing control section controlling writing of the pixel signal into the display section to be performed in each of the first period and the second period except for a leading period, the leading period being provided in each of the first period and the second period, and having a predetermined length from start of each of the first period and the second period.

(2) The drive circuit for display according to (1), in which

the pixel signal generation section does not invert the pixel signal at a start timing of each of the first period and the second period.

(3) The drive circuit for display according to (1) or (2), in which

a logic signal generation section is included, the logic signal generation section generating a logic signal with a logic level differing between the first period and the second period, and

the pixel signal generation section controls inversion of the pixel signal based on the logic signal.

(4) The drive circuit for display according to any one of (1) to (3), in which

a timing control section is included, the timing control section generating a vertical synchronization signal, and

the writing control section establishes the leading period based on the logic signal and the vertical synchronization signal.

(5) The drive circuit for display according to (4), in which

the writing control section includes

a flip-flop circuit sampling the logic signal in synchronization with the vertical synchronization signal, and

an exclusive OR circuit determining an exclusive OR of an output signal from the flip-flop circuit and the logic signal, and

the writing control section establishes the leading period based on an output signal from the exclusive OR circuit.

(6) The drive circuit for display according to any one of (1) to (5), in which

the display section includes pixel switches for a plurality of pixels, the pixel switches transmitting the pixel signal, and

the writing control section turns off the pixel switches in the leading period.

(7) The drive circuit for display according to (6), in which

the display section includes

pixel signal lines supplying the pixel signal to the plurality of pixels, and

signal-line switches supplying, to the pixel signal lines, the pixel signal supplied from the pixel signal generation section, and

the writing control section also turns off the signal-line switches in the leading period.

(8) The drive circuit for display according to (3), in which

the pixel signal generation section generates the pixel signal based on an image signal, and

the logic signal generation section detects motion in an image sequence based on the image signal, and determines lengths of the first period and the second period based on a detected result.

(9) The drive circuit for display according to (8), in which

when motion in the image sequence is not detected, the logic signal generation section adjusts the lengths of the first period and the second period to a predetermined minimum value,

when motion in the image sequence is detected, the logic signal generation section adjusts the lengths of the first period and the second period to become longer than the minimum value.

(10) The drive circuit for display according to (8), further including an OSD image generation section generating an OSD image and an OSD flag signal, the OSD flag signal being enable when the OSD image is displayed on the display section,

in which the logic signal generation section adjusts the lengths of the first period and the second period to the predetermined minimum value when the OSD flag signal is enabled.

(11) The drive circuit for display according to (8), further including an OSD image generation section generating an OSD image and an OSD flag signal, the OSD flag signal being enable when the OSD image is displayed on the display section,

in which the logic signal generation section switches the logic level of the logic signal when the OSD flag signal is enabled or disabled.

(12) The drive circuit for display according to any one of (1) to (11), in which

the pixel signal generation section generates the pixel signal based on an image signal,

the image signal is an interlaced signal, and

the display section includes the same number of pixels as that of pixels in a field image of the interlaced signal, and alternately displays a first field image and a second field image in each frame period.

(13) The drive circuit for display according to any one of (1) to (12), in which

the length of the leading period is equivalent to that of one frame period.

(14) A display including:

a pixel signal generation section generating a pixel signal, the pixel signal being inverted every frame period in each of a first period and a second period, the first period and the second period being alternately provided;

a display section performing display based on the pixel signal; and

a writing control section controlling writing of the pixel signal into the display section to be performed in each of the first period and the second period except for a leading period, the leading period being provided in each of the first period and the second period, and having a predetermined length from start of each of the first period and the second period.

(15) A method of driving a display including:

generating a pixel signal and supplying the pixel signal to a display section, the pixel signal being inverted every frame period in each of a first period and a second period, the first period and the second period being alternately provided; and

controlling writing of the pixel signal into the display section to be performed in each of the first period and the second period except for a leading period, the leading period being provided in each of the first period and the second period, and having a predetermined length from start of each of the first period and the second period.

The present application contains subject matter related to that disclosed in Japanese Priority Patent Application 2011-094165 filed in the Japan Patent Office on Apr. 20, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A drive circuit for display, the drive circuit comprising:
a pixel signal generation section generating a pixel signal and supplying the pixel signal to a display section, the pixel signal being inverted every frame period in each of a first period and a second period, the first period and the second period being alternately provided; and
a writing control section controlling writing of the pixel signal into the display section to be performed in each of the first period and the second period except for a leading period, the leading period being provided in each of the first period and the second period, and having a predetermined length from start of each of the first period and the second period.

2. The drive circuit for display according to claim 1, wherein
the pixel signal generation section does not invert the pixel signal at a start timing of each of the first period and the second period.

3. The drive circuit for display according to claim 1, wherein
a logic signal generation section is included, the logic signal generation section generating a logic signal with a logic level differing between the first period and the second period, and
the pixel signal generation section controls inversion of the pixel signal based on the logic signal.

4. The drive circuit for display according to claim 3, wherein
a timing control section is included, the timing control section generating a vertical synchronization signal, and
the writing control section establishes the leading period based on the logic signal and the vertical synchronization signal.

5. The drive circuit for display according to claim 4, wherein
the writing control section includes
a flip-flop circuit sampling the logic signal in synchronization with the vertical synchronization signal, and
an exclusive OR circuit determining an exclusive OR of an output signal from the flip-flop circuit and the logic signal, and
the writing control section establishes the leading period based on an output signal from the exclusive OR circuit.

6. The drive circuit for display according to claim 1, wherein
the display section includes pixel switches for a plurality of pixels, the pixel switches transmitting the pixel signal, and
the writing control section turns off the pixel switches in the leading period.

7. The drive circuit for display according to claim 6, wherein
the display section includes
pixel signal lines supplying the pixel signal to the plurality of pixels, and
signal-line switches supplying, to the pixel signal lines, the pixel signal supplied from the pixel signal generation section, and
the writing control section also turns off the signal-line switches in the leading period.

8. The drive circuit for display according to claim 3, wherein
the pixel signal generation section generates the pixel signal based on an image signal, and
the logic signal generation section detects motion in an image sequence based on the image signal, and determines lengths of the first period and the second period based on a detected result.

9. The drive circuit for display according to clam 8, wherein
when motion in the image sequence is not detected, the logic signal generation section adjusts the lengths of the first period and the second period to a predetermined minimum value,
when motion in the image sequence is detected, the logic signal generation section adjusts the lengths of the first period and the second period to become longer than the minimum value.

10. The drive circuit for display according to claim 8, further comprising an OSD image generation section generating an OSD image and an OSD flag signal, the OSD flag signal being enable when the OSD image is displayed on the display section,
wherein the logic signal generation section adjusts the lengths of the first period and the second period to the predetermined minimum value when the OSD flag signal is enabled.

11. The drive circuit for display according to claim 8, further comprising an OSD image generation section generating an OSD image and an OSD flag signal, the OSD flag signal being enable when the OSD image is displayed on the display section,
wherein the logic signal generation section switches the logic level of the logic signal when the OSD flag signal is enabled or disabled.

12. The drive circuit for display according to claim 1, wherein
the pixel signal generation section generates the pixel signal based on an image signal,
the image signal is an interlaced signal, and
the display section includes the same number of pixels as that of pixels in a field image of the interlaced signal, and alternately displays a first field image and a second field image in each frame period.

13. The drive circuit for display according to claim 1, wherein
the length of the leading period is equivalent to that of one frame period.

14. A display comprising:
a pixel signal generation section generating a pixel signal, the pixel signal being inverted every frame period in each of a first period and a second period, the first period and the second period being alternately provided;
a display section performing display based on the pixel signal; and
a writing control section controlling writing of the pixel signal into the display section to be performed in each of the first period and the second period except for a leading period, the leading period being provided in each of the first period and the second period, and having a predetermined length from start of each of the first period and the second period.

15. A method of driving a display comprising:
generating a pixel signal and supplying the pixel signal to a display section, the pixel signal being inverted every frame period in each of a first period and a second period, the first period and the second period being alternately provided; and
controlling writing of the pixel signal into the display section to be performed in each of the first period and the second period except for a leading period, the leading period being provided in each of the first period and the second period, and having a predetermined length from start of each of the first period and the second period.
